(19) United States
(12) Patent Application Publication
(10) Pub. No.: US 2008/0047052 A1
(43) Pub. Date: Feb. 28, 2008

(54) Flush valve with float

(76) Inventor: Joseph Han, Irvine, CA (US)

Correspondence Address: Myers Dawes Andras & Sherman LLP, Suite 1150, 19900 MacArthur Blvd., Irvine, CA, 92612, US

(21) Appl. No.: 11/894,458

(22) Filed: Aug. 21, 2007

Related U.S. Application Data
(60) Provisional application No. 60/840,186, filed on Aug. 25, 2006.

(51) Int. Cl. E03D 1/02; F16K 33/00

(52) U.S. Cl. 4/324; 441/133

(57) ABSTRACT

A flush valve apparatus for a toilet tank includes a float that provides a buoyancy force to a flush valve flapper. The float may be coupled to a chain connecting a lever and the flapper, or directly to the flapper. The float may be selected from a set of floats having a variety of sizes and shapes. Once a selected float is installed, the position of the float is fixed relative to the valve flapper, thus preventing change in the amount of water consumption per flush, which depends upon the buoyancy force on the flapper. For different standards, floats of different shapes and/or sizes may be selected such that the amount of water consumption per flush meets the standards.

### RELATED APPLICATIONS

This application relates to, claims priority from, and incorporates herein by reference, as if fully set forth, U.S. Provisional Patent Application Ser. No. 60/840,186, filed on Aug. 25, 2006 and entitled “FLOAT FLUSH VALVE.”

### BACKGROUND OF THE INVENTION

1. Field of the Invention

The present invention relates generally to toilet flush valves and particularly to floats for such toilet flush valves.

2. Description of Prior Art and Related Information

A toilet tank typically employs a flush valve that is levered open, which remains open until a predetermined amount of water flows from the tank into the toilet bowl through the flush valve. A fill valve provides water from a supply line to the toilet tank. The fill valve is open whenever the water level in the tank is below a predetermined level.

### SUMMARY OF THE INVENTION

In one aspect, the present invention provides a flush valve apparatus for releasing water from a toilet tank. The apparatus includes a flapper and a float device fixedly coupled to the flapper. The float device includes a float for providing a buoyancy force for the flapper and an anchoring member for anchoring the float to a predetermined location that is fixed relative to the flapper.

In a preferred embodiment, the flapper includes a cover, and the float is directly coupled to the flapper cover. The flapper cover may be substantially dome shaped, and the float is partially enclosed by the flapper cover. The anchoring member may include a push-on lock washer for anchoring the float to an extrusion on the flapper cover. The float may be selected from a kit or set of a variety of floats having different sizes for providing different buoyancy.

In another embodiment, the float device is fixedly coupled to a chain connecting the flapper with a lever. The float may also be selected from a kit or set including a plurality of floats having different sizes for providing different buoyancy forces. The float has an aperture for the anchoring member and the chain to extend therethrough. The anchoring member may have a shank portion having at least one extrusion to prevent the float device from sliding along the chain, and a head portion and a tail portion for securing the float therebetween. The head portion may have a partially conical surface configured for the head portion to squeeze through the aperture of the float. The tail portion may be partially disk-shaped, or may be partially conical shaped similar to the head portion. The head portion and the tail portion may each include a recess for retaining the chain, and the float is configured to wrap around the shank portion of the anchoring member and a portion of the chain, and is fixedly fitted between the head portion and the tail portion of the anchoring member.

In another aspect, the present invention provides a float device for a flush valve. The float device includes a float for providing a buoyancy force for a flapper of the flush valve, and an anchoring member for anchoring the float to a predetermined location that is fixed relative to the flapper.

In a preferred embodiment, the flapper comprises a cover, and the float is directly coupled to the flapper cover. The float may be selected from a kit or set including a plurality of floats having various sizes for providing different buoyancy forces.

In another embodiment, the float device is configured to couple to a chain connecting the flapper and a lever. The anchoring member may include a shank portion having at least one extrusion to prevent the float device from sliding along the chain, and a head portion and a tail portion for securing the float therebetween. The head portion and the tail portion may each include a recess for retaining the chain. The float may have an aperture adapted to have shank portion of the anchoring member and the chain extend therethrough, and the head portion may have a partially conical shape configured for the head portion to squeeze through the aperture of the float.

In another aspect, the present invention provides a method for installing a toilet flush valve system. The method includes determining an amount of water consumption per flush based on a specified standard, providing a float that provides a buoyancy suitable for the determined amount of water consumption per flush, and fixedly installing the float to the toilet flush valve system.

In a preferred embodiment, providing the float includes selecting the float from a kit or set including a plurality of floats having various sizes for providing various buoyancy forces. The method may further include replacing the float with another float that provides a different buoyancy force suitable for another standard.

In summary, a flush valve apparatus for a toilet tank includes a float that provides a buoyancy force to a flush valve flapper. The float may be coupled to a chain connecting a lever and the flapper, or directly to the flapper. The float may be selected from a set of floats having a variety of sizes and shapes. Once a selected float is installed, the position of the float is fixed relative to the valve flapper, thus preventing change in the amount of water consumption per flush, which depends upon the buoyancy force on the flapper. For different standards, floats of different shapes and/or sizes may be selected such that the amount of water consumption per flush meets the standards.

The invention, now having been briefly summarized, may be better appreciated by the following detailed description.

### BRIEF DESCRIPTION OF THE DRAWINGS

FIG. 1 is a side view of a toilet tank employing a flush valve including a float device in accordance with an embodiment of the invention;

FIG. 2 is a perspective view of the float device of FIG. 1;

FIG. 3 is a perspective view of an anchoring member configured to couple the float device of FIG. 2 to a chain;

FIG. 4 illustrates perspective views of floats of various sizes and shapes;

FIG. 5 is a cross-sectional view of a flush valve having a float directly coupled to a flapper cover in accordance with a preferred embodiment of the invention; and

FIG. 6 is a diagram illustrating a preferred method of installing the flush valve according to embodiments of the invention.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

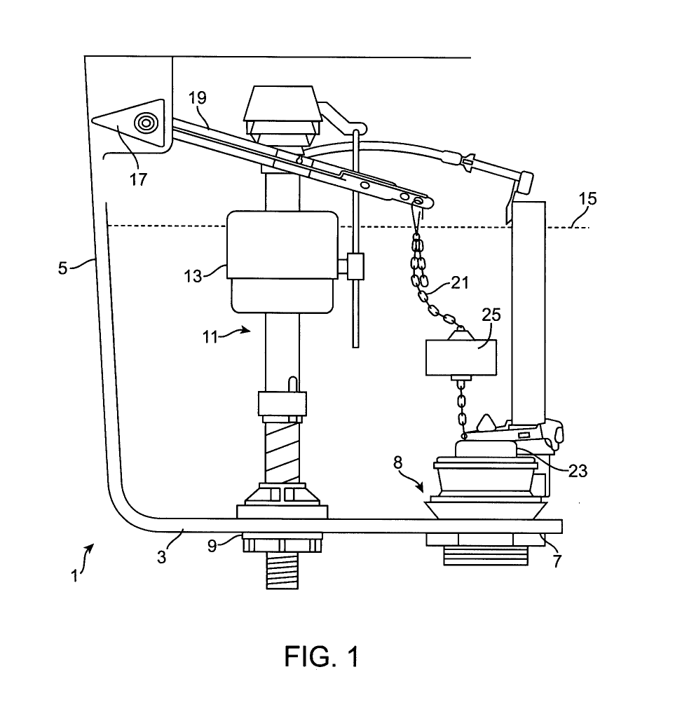

As shown in FIG. 1, a toilet tank 1 has a bottom 3 and a peripheral sidewall 5. A water discharge aperture 7 and an inlet aperture 9 are formed in the bottom 3 of the tank 1. The discharge aperture 7 is fitted with a flush valve 8 for discharging water to flush the toilet bowl, while the inlet aperture 9 fitted with a fill valve 11 for supplying water filling the tank 1.

The fill valve 11 is connected to a water supply line (not shown) at the inlet aperture 9, and is secured to the bottom 3 of the tank 1. A float 13 is wrapped around the valve body of the fill valve 11. Water under pressure in the tap through the inlet aperture 9 is conveyed through an inner cylinder of the fill valve 11 upwards. The float 13 follows the water level 15 to actuate the fill valve 11. The fill valve 11 remains open when the water or fluid level 15 in the tank 1 is below a predetermined elevation, and supplies water to the tank 1.

When a flush handle 17 is pressed, a lever 19 lifts a flapper 23 of the flush valve 8 through a chain 21, allowing the fluid in the tank 1 to flow into the toilet bowl through the flush valve 8. The flush valve 8 remains open until the buoyancy force on the flapper 23 is no longer sufficient for the flapper 23 to remain in its lifted state. As the flapper 23 drops, the fill valve 8 is sealed.

In the embodiment shown in FIG. 1, the flush valve apparatus 8 comprises a float device 25, which is of particular interest to the invention. The float device 25 is coupled to the chain 21, which connects the lever 19 and the flapper 23, at a predetermined position. The float device 25 provides at least a part of the buoyancy force for the flapper 23.

Both the float device 25 for the flush valve 8 and the float 13 for the fill valve 11 affect the amount of water consumption per flush. As discussed earlier, the float 13 for the fill valve 11 determines the predetermined water level in the tank 1. Not all of the water in the tank below the predetermined water level will be consumed for each flush. Rather, once the water level in the tank is below a residual level such that the buoyancy force on the flapper 23 is insufficient to sustain the flush valve in its “open” state, the fill valve 8 is closed by the flapper 23. Thus, the amount of water consumption per flush is the water between the predetermined level and the residual water level. Both the size and the location of the float device 25 affect the residual water level.

As the standardization for the water consumption per flush becomes important, embodiments of the invention provide ways of meeting different standards, for example, in different regions/countries.

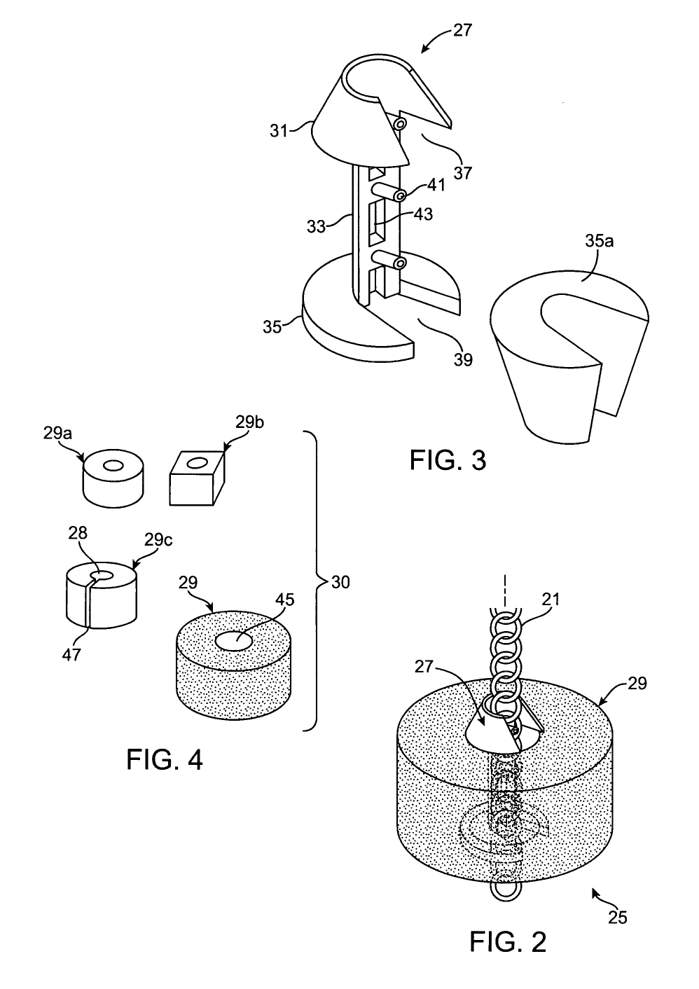

In accordance with an embodiment of the invention, as illustrated in FIG. 2, the float device 25 comprises an anchoring member 27 for fixedly coupling the float device to the chain 21, and a float 29. Preferably the float device 25 is fixedly coupled to the chain 21 during initial installation. After installation, an end user cannot slide the float device 25 along the chain 21. Thus, the end user cannot easily adjust the amount of water consumption per flush. Water consumption standard is thus enforced.

As shown in FIG. 3, the anchoring member 27 comprises a partially conical-shaped head portion 31, a shank portion 33, and a partially disk-shaped tail portion 35. The tail portion 35, in an alternative embodiment 35a may be also partially conical shaped similar to the head portion 31. That is, the tail portion 35a and the head portion 31 may be substantially symmetrical to save manufacturing cost and for ease of assembly. When the anchoring member 27 has a partially conical-shaped tail portion 35a in stead of the partially disk-shaped tail portion 35, it is no longer necessary to distinguish the “head” from the “tail.”

The head portion 31 has a recess 37, and the tail portion 35 has a recess 39. The recesses 37, 39 are configured to retain the chain 21 therein. The shank portion 33 has at least one extrusion 41 for preventing the float device 25 from sliding along the chain 21. The shank portion 33 may also have one or more recess 43 configured to hide a portion of the chain 21.

The anchoring member 27 may be made of, for example, polypropylene, polyethylene, Acetal, Polyester, or styrene-butadiene. The float 29 may be made of softer and more buoyant materials such as foam, rubber, or plastic. For factory installations, the float 29 is configured to have a proper size and shape to provide predetermined buoyancy.

A variety of floats having different sizes and/or shapes may be pre-manufactured as a kit or set. A desired float 29 may be selected from the set of off-the-shelf floats and meet a specific standard. In addition, for after market applications, it is possible to replace the float 29 with another from the set to meet a different standard.

FIG. 4 illustrates an exemplary set 30 including floats 29, 29a, 29b, and 29c. Among these floats, the float 29 has an aperture 45 for the anchoring member 27 and the chain 21 to extend therethrough. The head portion 31, or the partially conical shaped tail portion 35a if included, of the anchoring member 27 may be “squeezed” through the aperture 45 of the float 29, which is in turn fitted between the head portion 31 and the tail portion 35 or 35a and wraps around the shank portion 33 of the anchoring member 27 and a portion of the chain 21. The shank portion 33 may have a substantially semi-cylindrical shape to fit into the aperture 45 of the float 29.

A float with an appropriate size and shape is fitted onto the anchoring member 27. The float device 25 is subsequently installed in the toilet tank to provide a buoyancy force suitable for a predetermined amount of water consumption per flush according to a specific standard in a certain region/country. In a different region/country, to meet a different water consumption standard, a float of a different size can be installed. In addition, it is possible to install the float device 25 at a different location on the chain 21 during the initial installation to adjust the desired amount of water consumption per flush.

As also illustrated in FIG. 4, in accordance with one embodiment of the invention, the slotted float 29c has a gap or slot 47 to allow the shank portion 33 of the anchoring member 27 to squeeze therethrough. In this embodiment, it is not necessary to have the head portion 31 of the anchoring member 27 squeezed through the aperture 48.

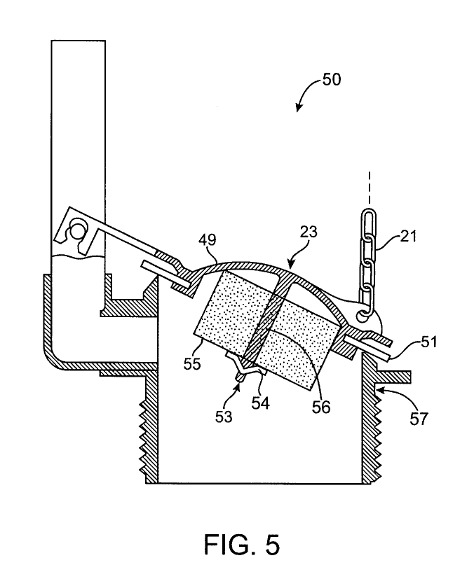

A preferred embodiment of the flush valve 50 according to the invention is illustrated in FIG. 5. As shown, the flapper 23 has a dome-shaped cover 49, a seal 51, and an anchoring member 53. The anchoring member 53 comprises a push-on lock washer 54 for coupling a float 55 directly to the flapper cover 49 at an extrusion 56. The anchoring member 53 may be provided with a diameter to accommodate the different floats shown in FIG. 4 such that a universal fit may be accomplished.

The extrusion 56 may be unitarily formed with the flapper cover 49, or may be coupled to the flapper cover 49. The dome-shaped cover 49 partially encloses the float 55.

By selecting the float 55 with the desired size and shape, different demands at different regions/countries for different standards of water consumption per flush can be met. On the other hand, once a float 55 of a specific shape and size is installed, tempering by the end user is difficult. Thus, a specified water consumption standard can be enforced.

As shown in FIG. 5, the seal 51 seals off the flush tube 57 of the flush valve 50 when the flapper 23 is in its “closed” state. In the closed state as illustrated, the float 55 does not sense the buoyancy from the water in the tank. Accordingly, a smaller float 55 may be sufficient for the buoyancy requirement as compared with the embodiment shown in FIG. 1.

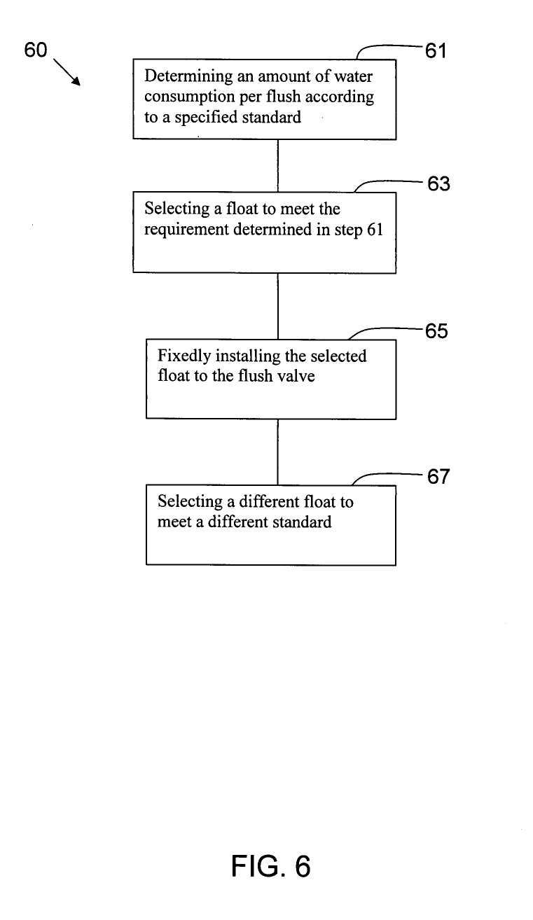

A preferred method 60 of installing the flush valve according to an embodiment of the invention is summarized in the flowchart in FIG. 6. In step 61, the amount of water consumption per flush is determined according to a specified regional standard, e.g., 1.6 gallon per flush according to some U.S. standards, or different standards according to, for example, European regulations. In step 63, a float is selected from, for example, a set of floats having a variety of shapes and sizes. The selected float will provide suitable buoyancy force to the flush valve flapper to meet the predetermined amount of water consumption per flush as determined in step 61. In step 65, the selected float is installed to the flush valve by coupling to the chain or directly to the flapper cover. Once installed, the float is anchored to a fixed location, thus preventing arbitrarily adjusting the amount of water consumption per flush. In step 67, for example in after market applications, a different float may be selected from an off-the-shelf set of floats to meet a different standard.

Advantageously, the float device according to embodiments of the invention prevents arbitrary adjustment of the float, thus providing a fixed amount of water consumption per flush for the toilet tank. This helps meeting certain water consumption standards. On the other hand, different standards in different regions can be met with floats of different sizes and/or shapes.

It is to be expressly understood that although some embodiments of the floats and anchoring means according to the invention have been described above with reference to the drawings, the float device may have other embodiments to be adapted to other configurations of toilet tanks. For example, in some toilet tanks, a string or a link is used in place of the chain 21. Accordingly, the anchoring member 27 may have variations suitable for fixedly coupling to the string or link by way of other shapes or configurations.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A flush valve apparatus for discharging fluid from a tank, comprising:
a flapper; and
a float device fixedly coupled to the flapper,
wherein the float device comprises:
a float for providing a buoyancy force for the flapper; and
an anchoring member for anchoring the float to a predetermined location that is fixed relative to the flapper.

2. The apparatus of claim 1, wherein the flapper comprises a cover, and wherein the float is directly coupled to the flapper cover.

3. The apparatus of claim 2, wherein the flapper cover is substantially dome shaped, and wherein the float is partially enclosed by the flapper cover.

4. The apparatus of claim 2, wherein the anchoring member comprises a push-on lock washer for anchoring the float to an extrusion on the flapper cover.

5. The apparatus of claim 2, wherein the float is selected from a set comprising a plurality of floats having various sizes for providing different buoyancy.

6. The apparatus of claim 1, wherein the float device is fixedly coupled to a chain connecting the flapper with a lever.

7. The apparatus of claim 6, wherein the float is selected from a set comprising a plurality of floats having different sizes for providing different buoyancy forces.

8. The apparatus of claim 6, wherein the float has an aperture for the anchoring member and the chain to extend therethrough.

9. The apparatus of claim 8, wherein the anchoring member comprises:
a shank portion having at least one extrusion to prevent the float device from sliding along the chain; and
a head portion and a tail portion for securing the float therebetween.

10. The apparatus of claim 9, wherein the head portion has a partially conical surface configured for the head portion to squeeze through the aperture of the float, and wherein the tail portion is partially disk shaped or partially conical shaped.

11. The apparatus of claim 10, wherein the head portion and the tail portion each comprise a recess for retaining the chain, and wherein the float is configured to wrap around the shank portion of the anchoring member and a portion of the chain, and is fixedly fitted between the head portion and the tail portion of the anchoring member.

12. A float device for a flush valve, comprising:
a float for providing a buoyancy force for a flapper of the flush valve; and
an anchoring member for anchoring the float to a predetermined location that is fixed relative to the flapper.

13. The device of claim 12, wherein the flapper comprises a cover, and wherein the float is directly coupled to the flapper cover.

14. The device of claim 12, wherein the float is selected from a set comprising a plurality of floats having various sizes for providing different buoyancy forces.

15. The device of claim 12, wherein the float device is configured to couple to a chain connecting the flapper and a lever.

16. The device of claim 15, wherein the anchoring member comprises:
a shank portion having at least one extrusion to prevent the float device from sliding along the chain; and
a head portion and a tail portion for securing the float therebetween.

17. The apparatus of claim 16, wherein the head portion and the tail portion each comprise a recess for retaining the chain,
the float has an aperture adapted to have shank portion of the anchoring member and the chain extend therethrough, and
the head portion has a partially conical shape configured for the head portion to squeeze through the aperture of the float.

18. A method for installing a toilet flush valve system, comprising:
determining an amount of water consumption per flush based on a specified standard;
providing a float that provides a buoyancy suitable for the determined amount of water consumption per flush; and
fixedly installing the float to the toilet flush valve system.

19. The method of claim 18, wherein providing the float comprises selecting the float from a set, and wherein the set comprises a plurality of floats having various sizes for providing various buoyancy forces.

20. The method of claim 19, further comprising selecting another float from the set for a different buoyancy force suitable for another standard.
